(19) United States
(12) Patent Application Publication
(10) Pub. No.: US 2020/0201383 A1
(43) Pub. Date: Jun. 25, 2020

(54) LAPHONE

(71) Applicant: Lucian Predescu, Lake St. Louis, MO (US)

(72) Inventor: Lucian Predescu, Lake St. Louis, MO (US)

(21) Appl. No.: 16/230,421

(22) Filed: Dec. 21, 2018

(51) Int. Cl. G06F 1/16; H04M 1/725; G06F 3/041; G06F 3/0354

(52) U.S. Cl. CPC G06F 1/1605; G06F 1/1688; G06F 1/1643; G06F 1/1616; G06F 1/1662; G06F 1/169; G06F 3/03545; G06F 1/1698; G06F 1/1626; G06F 1/1635; G06F 1/1681; H04M 1/72527; G06F 3/041; G06F 1/1632

(57) ABSTRACT

An embodiment of LAPHONE concept is provided for enhancing smartphone or tablet PC experience to a user. The present invention relates to a LAPHONE, more specifically, a LAPHONE system with a wireless charge cradle, a touchscreen display with adjustable support with hinges, a backlit keyboard, a keypad mouse, a wireless mouse, speakers, an AC adapter, status indicators, a camera, a stylus pen, a HDMI port, USB ports, memory card slot and reader, USB-C ports, audio ports, a microphone port, and HDMI port.

### STATEMENT REGARDING FEDERALLY SPONSORED RESEARCH OR DEVELOPMENT

Not Applicable

### FIELD

The present invention relates to a LAPHONE, more specifically, a LAPHONE system with a wireless charge cradle, a touch screen display, adjustable support with hinges, a backlit keyboard, a keypad mouse, a wireless mouse, speakers, an AC adapter, status indicators, camera, a stylus pen, a HDMI port, USB ports, USB-C ports, memory card slot and audio outputs.

### BACKGROUND

Electronic devices are used throughout our daily lives for many things including communication, entertainment, business, web surfing, ecommerce, social networking service, emails, and time management. Electronic devices are increasingly becoming more portable and more powerful allowing users to do an increasing amount of activities remotely in the course of daily life. For example, many people now have smart phones, tablet PCs, notebooks and desktop PCs which allow them to access e-mail, surf the web, and do other activities in addition to phone services. Carrying smart phones, tablet PCs, and notebooks would be a big problem for most people. As these electronic devices are generally designed for mobile communication, entertainment, and time management, many times users are away from the home, office, or other locations where they may easily charge the device. Furthermore, when quick charging of a portable device before the battery fails is required, finding the right cord with the correct voltage and ampere might not be easy for novice people and managing multiple charge cords tangled at the electric outlet might be cumbersome task for most people.

This present invention relates generally to devices for enhancing capabilities of smartphones or a tablet PC while providing electric power to a portable device like smartphones or tablet PCs. It would be convenient and nice to have one device bridge our portable technological needs. In our rapidly evolving technological era, we have become dependent on a variety of these indispensable devices including laptops and tablets. This present invention will solve our modern problem of the need to carry multiple devices. There will always be a need to upgrade smartphones, tablets and laptops every time a new technology appears on the market or more memory space is required due to the popularity of digital photos and home videos.

LAPHONE takes our most used and most important portable device: the cellphone or tablet PC; and merges it into a device creating a laptop-like experience. The LAPHONE enhances your phone or tablet PC up to laptop and/or tablet capabilities. Furthermore, the LAPHONE provides wireless charging solution to a smartphone user.

This present invention narrows the gap between the phone, the tablet PC and the laptop by taking advantage of the exponential growth of future processing power of cell phones and tablet PCs and allowing us to essentially turn our cell phone into a laptop or our tablet PC into a laptop, or what we are calling LAPHONE.

### SUMMARY

This present invention, LAPHONE, is a stand-alone device that connects to your personal phone or PC via Bluetooth, USB port, Wi-Fi direct, or other future connection types. Your phone or tablet PC is the main CPU and GPU unit, but LAPHONE allows you to access your phone or your tablet PC on a worker friendly platform.

An important part of this invention is the software that resides on the unit. The software manages all the hardware and peripheral resources connected to it. The software allows data transfer back and forth giving user access to the phone's resources. The Graphical User Interface (GUI) will enhance the phone's visual and touch experience on a larger interface. A Mobile app completes secure pairing between the phone and LAPHONE unit allowing access to the phone's data and resources.

The unit will contain a high-quality touchscreen display with an attached backlit keyboard. The unit is foldable and will be lightweight for easy transportation. The backlit keyboard when folded will act as an additional screen protector. The unit will contain an indwelling stylist for easy screen navigation, as well as Bluetooth mouse capabilities. The unit will contain stereo speakers, microphone, and additional memory for backing up the phone or extra upgradable storage (120 Gb plus). The unit will be equipped with its own battery; capable of also charging your phone, as well as an extendable wireless charging arm (Qi) that is compliant with all wireless charging solutions for charging the phone while you work on it. The unit will be Equipped with USB ports, USB-C ports and memory card slot and reader, HDMI port, as well as a dedicated memory card for memory extension. The unit has a power circuit connected to a power source and it is configured to supply the unit with electrical power. A plurality of status indicators including connection status, charging status and AC power status will be present on the unit.

Once the unit is in proximity with your phone it automatically asks for connection permission, once you agree, the phone will be connected with the unit; it will be ready to be used.

Different Models Description
1) The base model unit will not have any processing power of its own, except the hardware and software necessary to interact with your phone or connect with different apps. The unit will use the phones processing power thus enhancing the phone screen capability and peripheral connections.
2) Next upgraded version of this unit will have all the base model capabilities plus it will run applications separate from the phone. This unit will have lower performance allowing phone apps to be installed on it; apps that require enhanced screen capability for a friendly user interface such as MS Office, web browsers, Adobe Acrobat, etc.
3) The most upgraded units will contain all previous models' features and could be used completely independent from the phone having their own full processing power.

The unit will be produced in two styles, laptop model and tablet PC model. Any accessory will be added separately.

Both models will allow third party accessories to be added based on user preference or needs.

LAPHONE will have the following advantages:
1) This unit will decrease the number of indispensable devices we carry with us daily.
2) This unit will maximize our cell phones capabilities.
3) This unit will increase your cell phone's storage capacity. Phones can be easily backed up on the device without any cloud storage.
4) Multiple users can use the same unit for different phones, or single user setup can create a unique system device.
5) When this unit connects to a tablet PC it functions like a second display; duplicate or extended screen. This is most useful for presentations or personal use with multiple applications.
6) This unit can extend the turn over time of phones since it can add memory space to devices and larger size screen.
7) This unit will offer customers a less expensive option for the need of future upgrades. The Laphone could be upgraded before a smart phone upgrade is necessary. Upgrading the Laphone instead of a cellphone will be more cost effective to stay on the cutting edge of technology.
8) There is no need for additional or separate data plans for other smartphones, tablet PCs, or laptop devices. Your phone's data plan is all that is needed.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Various embodiments of the invention are disclosed in the following detailed description and accompanying drawings.

FIG. 1 is a system view of a LAPHONE showing smartphone, wireless charge cradle, touchscreen, adjustable support with hinges, detachable speakers, internal speakers, backlit keyboard, USB, USB-C, memory card slot and reader, mouse touchpad and camera.

FIG. 2 is a system view of a LAPHONE showing smartphone, touchscreen, adjustable support with hinges, detachable speakers, backlit keyboard, audio ports, a microphone port, HDMI, mouse touchpad, AC Cable and AC.

FIG. 3 is a system view of a wireless charge cradle of an LAPHONE showing adjustable holder of charge cradle and smartphone.

FIG. 4 is a system view of a LAPHONE showing a tablet PC, adjustable support with hinges for tablet PC, internal speakers, backlit keyboard, USB, USB-C, memory card slot and reader, mouse touchpad, stylus pen, camera and wireless mouse.

The following numbers represent the various parts of a LAPHONE:

1. Smartphone

2. Wireless Charge Cradle

3. Touchscreen Display

4. Adjustable Support with Hinges for Touchscreen Display

5. Detachable Speakers

6. Internal Speakers

7. Backlit Keyboard

8. USB ports, USB-C ports, Memory Card Slot and Reader

9. Audio ports, Microphone port, HDMI port

10. Mouse Touchpad

11. Camera

12. AC Cable

13. Adjustable Holder of Charge Cradle

14. AC Adapter port

15. Stylus Pen

16. Wireless Mouse

17. Adjustable Support with Hinges for Tablet PC

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teasing on skilled in the art to variously employ the present invention.

For example, systems and methods for controlling and interfacing with keyboards, mouse, display, and other peripherals would be provided through a mobile application deployment and update platform. Preferably, these systems and methods are implemented in an Internet based environment that allows non-technical users to download sophisticated, highly-customizable cross-platform mobile applications. When the mobile application is installed on, or executed by the mobile device, the configuration file and the resources may enable the retrieval of various data or settings associated with the mobile application in LAPHONE.

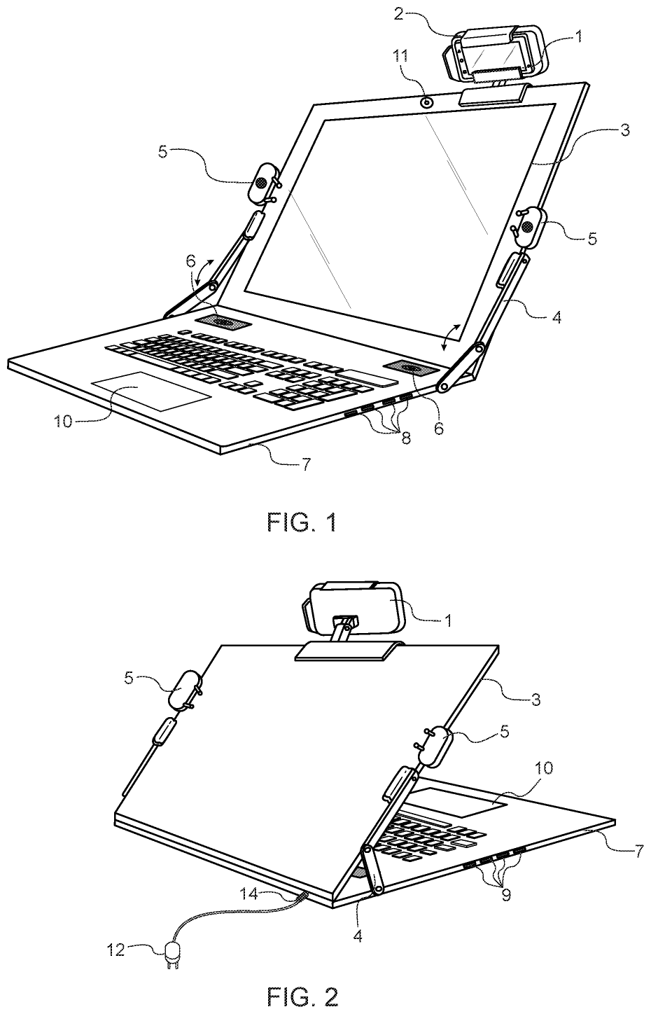

Referring now to FIG. 1, the system view of LAPHONE showing a smartphone 1, a wireless charge cradle 2, a touchscreen with display 3, adjustable support with hinges 4, detachable speakers 5, internal speakers 6, a backlit keyboard 7, USB ports, USB-C ports, memory card slot and reader 8, a mouse touchpad 10 and a camera 11 is shown. Wireless charge cradle 2 is attached to the top of touchscreen 3 to provide wireless charging solution to a smartphone user. Adjustable support with hinges 4 may be designed to provide for the desired angle of viewing for a user. Detachable speakers 5 may be attached to the sides of touchscreen 3 to enhance the sound experience to a user. USB ports and USB-C ports 8 may be used for charging and interfacing with other devices.

Referring to FIG. 2, the system view of a LAPHONE showing a smartphone 1, a touchscreen with display 3, adjustable support with hinges 4, detachable speakers 5, backlit keyboard 7, audio ports, a microphone port, a HDMI port 9, a mouse touchpad 10, an AC cable 12 and an AC adapter port 14 is shown. Adjustable support with hinges 4 may be designed to provide for the desired angle of viewing for a user. Detachable speakers 5 may be attached to the sides of touchscreen 3 to enhance the sound experience to a user. LAPHONE has a power circuit connected to AC adapter port 14 and it is configured to supply the unit with electrical power from AC Cable 12.

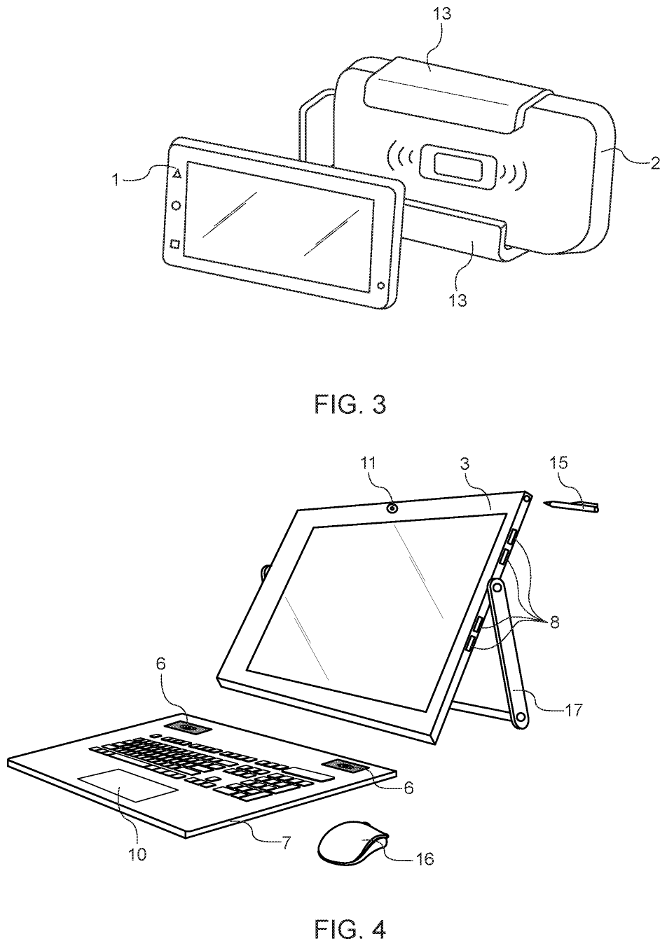

Referring to FIG. 3, the system view of a wireless charge cradle 2 of an LAPHONE showing adjustable holder of charge cradle 13 and smartphone 1 is shown. Adjustable holder of charge cradle 13 may be designed to hold a smartphone securely while charging.

According to FIG. 4, the alternative system view of a LAPHONE showing a tablet PC or touchscreen with display 3, adjustable support with hinges for tablet PC 17, internal speakers 6, backlit keyboard 7, USB, USB-C, memory card slot and reader 8, a mouse touchpad 10, a stylus pen 15, camera 11 and a wireless mouse 16 is shown. Adjustable support with hinges for tablet PC 17 may be designed to provide for the desired angle of viewing for a user. A stylus pen 15 is a small pen-shaped instrument that is used to input commands to tablet PC. With touchscreen tablet PC 17, a user places a stylus pen 15 on the surface of the screen to draw or make selections by tapping the stylus pen 15 on table PC 17.

It is to be understood that variations and modifications can be made on the aforementioned structure without departing from the concepts of the present invention, and further it is to be covered by the following claims unless these claims by their language expressly state otherwise.

1. A device comprising of two speakers, a touchscreen display with adjustable support with hinges, a backlit keyboard, a touch mousepad, a wireless charge cradle, status indicators, a camera, two USB ports, two USB-C ports, one memory card slot and reader, one audio port, a microphone port, one HDMI port, a wireless mouse, a stylus pen, adjustable support hinges, an AC adapter and an AC adapter port.

2. The device of claim 1, wherein speakers are attached to the device.

3. The device of claim 1, wherein a touchscreen display with adjustable support hinges is attached to the device.

4. The device of claim 1, wherein a backlit keyboard as an input device is attached to the device.

5. The device of claim 1, wherein a touch mousepad as an input device is attached to the device.

6. The device of claim 1, wherein a wireless charge cradle that is compliant with all wireless charging solution and that holds a chargeable smartphone securely is attached to the device.

7. The device of claim 1, wherein a plurality of status indicators are attached to the device.

8. The device of claim 1, wherein a wireless camera is attached to the device.

9. The device of claim 1, wherein USB ports, USB-C ports and memory card slot and reader are attached to the device.

10. The device of claim 1, wherein audio outputs, a microphone port, and a HDMI port are attached to the device to enhance the multimedia experence a user.

11. The device of claim 1, wherein a wireless mouse as an input device is attached to the device.

12. The device of claim 1, wherein adjustable suport hinges are attached to the device.

15. A device comprising of two speakers, adjustable support with hinges for tablet PC, a backlit keyboard, a touch mousepad, status indicators, a camera, speakers, two USB ports, two USB-C ports, one memory card slot and reader, one audio port, a microphone port, one HDMI port, a wireless mouse, a stylus pen and support hinges.

16. The device of claim 15, wherein a wireless stylus pen as an input device for tablet PC is attached to the device.

17. The device of claim 15, wherein adjustable support with hinges for tablet PC is attached to the device.

18. The device of claim 15, wherein a backlit keyboard as an input device is attached to the device.

19. The device of claim 15, wherein a touch mousepad as an input device is attached to the device.

20. The device of claim 15, wherein a wireless mouse as an input device is attached to the device.

21. The device of claim 15, wherein speakers are attached to the device.

22. The device of claim 15, wherein USB ports, USB-C ports and memory card slot and reader are attached to the device.

23. The device of claim 15, wherein audio ports, a microphone port and HDMI port are attached to the device to enhance the multimedia experience to a user.
